(19) United States
(12) Patent Application Publication
(10) Pub. No.: US 2020/0051374 A1
(43) Pub. Date: Feb. 13, 2020

(54) GAMING MACHINES AND METHODS OF GAMING WITH RANDOM NUMBER GENERATION

(71) Applicant: Atlas Gaming Technologies Pty Ltd., Port Melbourne (AU)

(72) Inventors: Zenja Solaja, Port Melbourne (AU); Alessandro Ciampoli, Port Melbourne (AU)

(73) Assignee: Atlas Gaming Technologies Pty Ltd., Port Melbourne (AU)

(21) Appl. No.: 16/538,283

(22) Filed: Aug. 12, 2019

(30) Foreign Application Priority Data
Aug. 13, 2018 (AU) 2018902963

(51) Int. Cl. G07F 17/32

(52) U.S. Cl. CPC G07F 17/3223; G07F 17/3267; G07F 17/3211

(57) ABSTRACT

Some embodiments relate to a gaming machine and gaming method. The gaming machine comprises: a memory component, a display screen, input components and at least one processor. The memory component stores: executable program code, virtual object data relating to a predetermined set of virtual objects, wherein each virtual object has at least one identifier, and a pay table defining a set of winning combinations of virtual objects. The at least one processor is configured to execute the program code to: receive start input from one of the input components to start play of a game of chance; in response to receiving the start input, generate a main subset of virtual objects by random selection from the predetermined set of virtual objects; generate and display a revealing animation of the at least one identifier for each of the virtual objects from the main subset in an array on the display screen; and determine whether one or more combinations of virtual objects from the main subset correspond to a winning combination based on the identifiers of the virtual objects. In response to determining that no combination from the main subset corresponds to a winning combination, the at least one processor executes the program code to: determine a near miss event when predetermined criteria are met, generate a bonus object by random selection from a subset of the predetermined set of virtual objects that excludes the main subset, and generate and display a bonus animation that reveals the identifier of the bonus object in the array; replace a virtual object in the main subset that contributed to the near miss event with the bonus object; and determine whether replacing the virtual object from the main subset with the bonus object results in one or more new combinations corresponding to a winning combination.

### CROSS-REFERENCE TO RELATED APPLICATION

The present application claims the benefit of and priority to AU Application No. 2018902963, filed Aug. 13, 2018, the entire disclosure of which is hereby incorporated herein by reference.

### TECHNICAL FIELD

The described embodiments relate to gaming machines and methods for operating gaming machines. More specifically, the described embodiments relate to gaming machines and methods for operating gaming machines having virtual objects based on a generated random number.

### BACKGROUND

A gaming machine, in its very basic form, allows a player to place a wager and produces a game play outcome that determines a player winning or losing the wager. The outcome of a random number generator of the gaming machine is primarily presented to the player on the gaming machine display device with appealing graphics and animations.

Gaming machines allow players to make bets on symbols that may appear on a reel or virtual reels, offering awards to a player based on a plurality of matching symbols that appear. Gaming machines sometimes include a jackpot value that may be won by the player. These games appeal to players as a way of winning cash or credits which may be redeemed in cash.

The player can interact with the gaming machine in a number of ways, for example by pressing mechanical buttons (or switches) or by touching a screen. The gaming machine software will respond to a player's input, such as by displaying graphics, animations and sounds, and alter an internal software state to reflect the new presentation. For instance, a touch screen icon will transition from a depressed representation to a pressed representation, and the software will act on a virtual button press (by invoking an action corresponding to the icon representation).

Gaming machines may present graphical icons corresponding to virtual buttons on the screen for the player to interact with, where only a single touch action would be processed on either touch down (touch action detected when the screen is touched), touch up (touch action no longer detected, corresponding to the finger no longer touching the screen) or both touch down and touch up.

Gaming machines may also present graphical interpretations of realistic objects, such as a wheel to spin or a lever to pull, in which a touch motion (linear or angular swipe) will advance the software state (such as start a wheel spin or activate a new game segment).

It is desired to address or ameliorate one or more shortcomings or disadvantages associated with prior methods, systems and machines for gaming, or to at least provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a gaming machine, comprising:

a memory component storing:

executable program code,

virtual object data relating to a predetermined set of virtual objects, wherein each virtual object has at least one identifier, and

a pay table defining a set of winning combinations of virtual objects;

a display screen;

input components to receive player input; and

at least one processor configured to execute the program code to:

receive start input from one of the input components to start play of a game of chance;

in response to receiving the start input, generate a main subset of virtual objects by random selection from the predetermined set of virtual objects;

generate and display a revealing animation of the at least one identifier for each of the virtual objects from the main subset in an array on the display screen;

determine whether one or more combinations of virtual objects from the main subset correspond to a winning combination based on the identifiers of the virtual objects;
in response to determining that no combinations from the main subset correspond to a winning combination:
determine a near miss event when predetermined criteria are met,
generate a bonus object by random selection from a subset of the predetermined set of virtual objects that excludes the main subset, and
generate and display a bonus animation that reveals the identifier of the bonus object in the array;

replace a virtual object in the main subset that contributed to the near miss event with the bonus object; and

determine whether replacing the virtual object from the main subset with the bonus object results in one or more new combinations corresponding to a winning combination.

The processor may be configured to:

display a set of first visualisations representing the main subset of virtual objects in the array on the display screen, wherein the first visualisations do not reveal the identifiers of the virtual objects; and

replace each first visualisation with a corresponding second visualisation to thereby reveal the identifiers of the virtual objects.

The processor may be configured to display an animation of the set of first visualisations being progressively displayed in the array.

The displayed animation may progressively reveal the identifiers of the selected virtual objects.

Determining the near miss event may comprise determining that a winning combination would occur if one or more predetermined virtual objects were present in a predetermined set of positions in the array.

There may be one or two predetermined virtual objects.

The predetermined criteria for the near miss event may comprise a predetermined number of un-matched virtual objects from a winning combination in a predetermined set of positions in the array.

The predetermined set of positions may comprise positions in either the first or last column of the array.

The processor may be further configured to execute program code to:

receive play line input from at least one of the input components indicative of a number of play lines selected for play of the game of chance, and

wherein combinations of virtual objects from the main subset lie along predetermined play lines, and each play line passes through one virtual object in each column of the array.

The start input from the player may comprise an indication of a bet denomination.

The predetermined criteria are at least partially satisfied when there are at least two virtual objects in each combination that match virtual objects in at least one winning combination.

When the bet denominator is larger than a predetermined amount and the new combination does not match a winning combination, the processor may be further configured to:

generate a further bonus object by random selection from the predetermined set of virtual objects; and

generate and display a subsequent bonus animation that reveals the identifier of the further bonus object to replace at least one of the previously revealed bonus object in the array.

The generation of further bonus objects and generation and display of subsequent bonus animation may be repeated a number of times depending on the size of a bet denomination. The bet denomination may be a multiple of a minimum bet denomination.

The number of times the generation of further bonus objects and generation and display of subsequent bonus animation is repeated may be linearly proportional to the multiple of the minimum bet denomination.

The array may define at least 5 columns. The array may define at least 3 rows.

The virtual objects may be displayed as playing cards. The revealing animation may simulate the playing cards being flipped from face down to face up. The identifiers of the virtual objects may be represented by a value symbol and a class symbol.

Some embodiments relate to a gaming machine, comprising:

a memory component storing:

executable program code,

virtual object data relating to a predetermined set of virtual objects, wherein each virtual object has at least one identifier, and

a pay table defining a set of winning combinations of virtual objects;

a display screen;

input components to receive player input; and

at least one processor configured to execute the program code to:

receive start input from one of the input components to start play of a game of chance;

in response to receiving a start input, generate a main subset of virtual objects by random selection from the predetermined set of virtual objects;

generate and display a revealing animation of the at least one identifier for each of the virtual objects from the main subset in an array on the display screen;

determine whether one or more combinations of virtual objects from the main subset correspond to a winning combination based on the identifiers of the virtual objects;

generate a bonus object by random selection from the predetermined set of virtual objects;

in response to determining that no combinations from the main subset correspond to a winning combination:

determine a near miss event when a predetermined criteria is met, and

generate and display a bonus animation that reveals the identifier of the bonus object in the array;

determine whether replacing one or more virtual objects from the main subset with the bonus object results in one or more new combinations corresponding to a winning combination.

The bonus object may replace at least part of the missing virtual objects from the main subset with the bonus object.

The predetermined set of virtual objects may comprise a predetermined number of free-game virtual objects, wherein if one or more free-game virtual objects is selected as part of the main subset for the game of chance, then at least one free game play of the game of chance is awarded to a player of the gaming machine. A number of free game plays awarded may depend on the number of free-game virtual objects selected as part of the main subset and/or depends on the position of the respective free-game virtual objects in the array.

The predetermined set of virtual objects may comprise a predetermined number of wild-card virtual objects, wherein if one or more wild-card virtual objects is selected as part of the main subset for the game of chance, then the processor allocates to the at least one wild-card virtual object at least one identifier to attempt to make a winning combination of virtual objects.

Some embodiments relate to method of operating a gaming machine, comprising:

receiving start input from an input component of the gaming machine to start play of a game of chance;

in response to receiving the start input, generating a main subset of virtual objects by random selection from a predetermined set of virtual objects;

generating and displaying a revealing animation of at least one identifier for each of the virtual objects from the main subset in an array on a display screen of the gaming machine;

determining whether one or more combinations of virtual objects from the main subset correspond to a winning combination based on the identifiers of the virtual objects in the main subset;

in response to determining that no combinations from the main subset correspond to a winning combination:
determining a near miss event when predetermined criteria are met,
generating a bonus object by random selection from a subset of the predetermined set of virtual objects that excludes the main subset, and
generating and displaying a bonus animation that reveals the identifier of the bonus object in the array;

replacing a virtual object in the main subset that contributed to the near miss event with the bonus object; and

determining whether replacing the virtual object from the main subset with the bonus object results in one or more new combinations corresponding to a winning combination.

Some embodiments relate to a method of operating a gaming machine, comprising:

receiving start input from an input component of the gaming machine to start play of a game of chance;

in response to receiving a start input, generating a main subset of virtual objects by random selection from a predetermined set of virtual objects;

generating and displaying a revealing animation of at least one identifier for each of the virtual objects from the main subset in an array on a display screen of the gaming machine;

determining whether one or more combinations of virtual objects from the main subset correspond to a winning combination based on the identifiers of the virtual objects;

generating a bonus object by random selection from the predetermined set of virtual objects;

in response to determining that no combinations from the main subset correspond to a winning combination:

determining a near miss event when predetermined criteria are met, and

generating and displaying a bonus animation that reveals the identifier of the bonus object in the array;

determining whether replacing one or more virtual objects from the main subset with the bonus object results in one or more new combinations corresponding to a winning combination.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments are described below in further detail and by way of example, with reference to the accompanying drawing, in which:

FIG. 1 is a diagrammatic representation of a gaming system in accordance with some embodiments, implemented in the form of a stand-alone gaming machine;

FIG. 2 is a schematic block diagram of core components of the gaming system of FIG. 1;

FIG. 3 is a schematic diagram of a gaming system in accordance with some embodiments, with the gaming system implemented over a network;

FIG. 4 is a schematic block diagram of the software components of a gaming system according to some embodiments;

FIG. 5 is a screen shot of a display illustrating an example of a rectangular array 512 of virtual objects;

FIG. 6 is a diagram showing various play lines through the rectangular array 512 of virtual objects shown in FIG. 5;

FIG. 7 is an example of a screen shot of a display illustrating an example of a pay table;

FIG. 8 is a flowchart illustrating a method of executing a game of chance according to some embodiments;

FIG. 9 is a screen shot of a display illustrating an example of a bonus object replacing a main object in a rectangular array 512;

FIG. 10 is a screen shot of a display illustrating an example of a revealing animation in the process of progressively revealing values of virtual objects in the game of chance;

FIG. 11 is a screen shot of a display illustrating an example of a winning combination of virtual objects along a play line;

FIG. 12 is a screen shot of a display illustrating an example of a foreground animation displayed following determination of a winning combination;

FIG. 13 is a screen shot of a display illustrating an example of repeat replacement of a virtual object with a bonus object when a near miss event occurs;

FIG. 14 is a screen shot of a display illustrating an example of a winning combination comprising a wild-card;

FIG. 15 is a screen shot of a display illustrating an example of a set of randomly selected virtual objects resulting in free-games being won;

FIG. 16 is screen shot of a display illustrating an example of a free-game mode; and

FIG. 17 is screen shot of a display illustrating an example of part of the revealing animation to display the array 512 of virtual objects;

FIG. 18 is a screen shot of a display illustrating an example set of randomly selected virtual objects that are in the process of being revealed in the revealing animation and that show a possible large win once the final column of virtual objects are revealed (turned face up).

### DETAILED DESCRIPTION

The embodiments described herein relate to gaming machines and methods for gaming. More specifically, the described embodiments relate to gaming machines and methods for gaming that display virtual objects selected based on a generated random number.

Gaming machines such as slot or pokies machines typically display a random selection of symbols in a rectangular array 512 defining rows and columns of symbols. A plurality of play lines are defined where each play line passes through one symbol in each column. The play line may have horizontal or diagonal sections to connect adjacent symbols or symbols that are directly diagonal to each other. For example, in a 3 row and 5 column rectangular array 512 of symbols, there may be 243 different play lines defined (ways to play). A combination of symbols that a play line passes through may be determined to be a winning combination if it matches one or more winning combinations. A prize may be awarded as a result of determining a winning combination. For example, if 3 or more matching symbols lie along one or more play lines.

The present disclosure describes systems and methods that provide additional combinations of symbols to provide a win. This increases the chances for a win and may also lead to greater excitement and/or enjoyment from the player of the gaming machine.

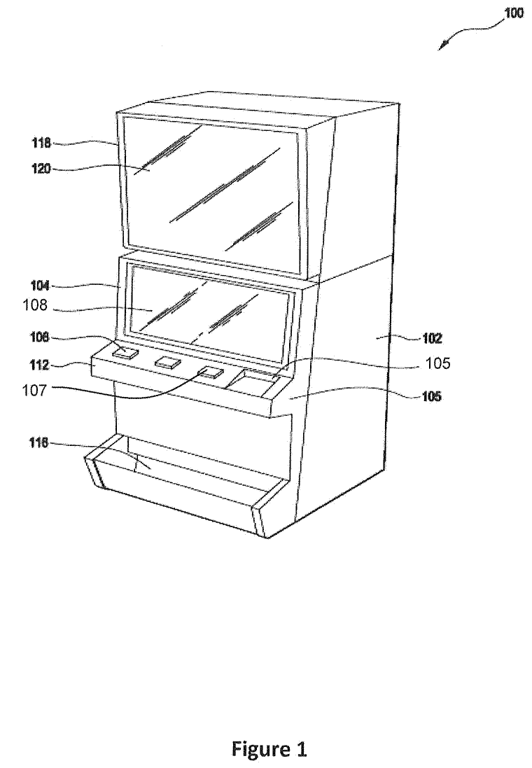

In FIG. 1, reference numeral 100 generally designates a stand-alone gaming system including a game. A stand-along gaming system may be a system which can operate by itself based on inputs received from a player and which requires no further interaction from other systems. Hereinafter, the stand-alone gaming system 100 will be referred to as a gaming machine 100.

The gaming machine 100 includes a console 102 which contains all or most components required to implement a game play whereby a player wins or loses a wager. Access to the interior components is by way of a hinged door 105. Moulded or otherwise affixed to the exterior of the console 102 is a display means in the form of at least one visual display unit 104 on which one or more games is played. The video display unit 104 may be implemented as a liquid crystal display, a plasma screen, as a cathode ray screen device or the like. According to some embodiments, visual display unit 104 may comprise a touch screen display. What is displayed on the visual display unit 104 will depend on what the intended goal of the unit is in relation to the player and any other potential participants in the gaming system.

According to some embodiments, gaming machine 100 may comprise more than one display means. For example, in the illustrated embodiment, gaming machine 100 includes a top box 118 on which secondary screen 120 is carried in the form of an electronic visual display unit. According to some embodiments, instead of a secondary screen 120, top box 118 may comprise other display means, which could include displays made from physical materials such as paper, plastic banners or posters. The secondary screen 120 or other display means may display generic information related to the machine or gaming system, or secondary screen 120 may display information specifically relating to a particular game to be played on the machine 100. Whilst the secondary screen 120 is shown as being carried on the top box 118, secondary screen 120 can also be positioned in or on the bottom panel of the door 105, or any other part of the gaming machine 100 visible to the player.

According to some embodiments, one or more of visual display unit 104 and secondary screen 120 may be configured to display 1920×1080 pixels resolution at a 60 Hz refresh rate. According to some embodiments, one or more of visual display unit 104 and secondary screen 120 may be flat. In some embodiments, one or more of visual display unit 104 and secondary screen 120 may be curved. One or more of visual display unit 104 and secondary screen 120 may be concavely curved along the horizontal axis so that the side edges of the screen curve toward a position in front of the gaming machine 100 where the player would normally be.

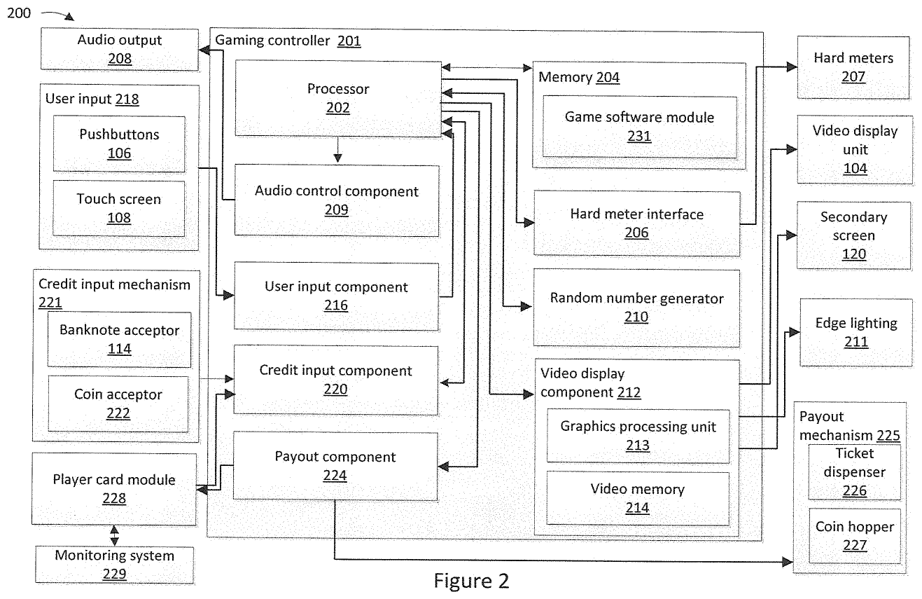

In some embodiments, one or more of visual display unit 104 and secondary screen 120 may comprise edge lighting 211 (shown in FIG. 2). Edge lighting 211 may be LED lighting located around the edge of visual display unit 104 and/or secondary screen 120, and may be configured to switch on and off and/or change colour during gameplay.

The gaming machine 100 includes a tactile user input 218 (shown in FIG. 2) configured to allow a player to interact via touch with the gaming machine 100. In this example, the tactile input is in the form of a combination of pushbuttons 106 and a touch screen 108 for enabling a player to play one or more games. The touch screen 108 comprises an electronic visual display that can detect the presence and location of a touch within the display area. According to some embodiments, touch screen 108 may be integrated into at least one of video display unit 104 and secondary display unit 120. The touch screen 108 may be used in between the end of a game and the start of a next game, for example for the player/user to access game information and/or do a limited amount of configuration, such as adjust screen brightness, volume or other functional aspects not affecting a game outcome.

The touch screen 108 may be used during the game play between the start of a game and the end of a game. According to some embodiments, a game is considered to have started once a wager is placed and considered complete once the wager has been lost or won. Pushbuttons 106 may include one or more buttons which are physically actuatable by a user. Functions of pushbuttons 106 may include: initiation of game play, credit output, gameplay selection, completion of gameplay etc. A midtrim 112 of the machine 100 houses the pushbuttons 106.

It should be appreciated that tactile user input 218 may include any suitable device that enables the player to produce an input signal that is received by the processor. Tactile input in the form of pushbuttons 106 and/or regions on touch screen 108 may include a one bet button, a max bet button, or a repeat-the-bet button. With a one bet button, for instance, the player places a bet by pushing the one bet button. The player may increase the bet by one credit each time the player pushes the one bet button.

The midtrim 112 also houses a credit input mechanism 221 (shown in FIG. 2), including a banknote acceptor 114, configured to accept banknotes and provide a player with a corresponding amount of credit. According to some embodiments, banknote acceptor 114 may also be configured to operate as a ticket-in-ticket-out device, accepting tickets representative of a credit amount. Such tickets may be printed by other machines located in a gaming venue. Banknote acceptor 114 may be configured to communicate with credit input component 220 via a specific protocol over a serial link, which may be a RS232 link, or similar. The credit input mechanism 221 may further include a coin acceptor 222 (shown in FIG. 2), configured to accept coins and provide a player with a corresponding amount of credit. According to some embodiments, gaming machine 100 may optionally include a player card module 228 (shown in FIG. 2), which may act as a credit input mechanism in some embodiments, player card module 228 may comprise, a card and/or ticket reader, a magnetic reading head for reading a magnetic stripe card, an electronic reader for a proximity card, a near field communications reader or any other form of electronic, wireless or contact that can input credit to the gaming machine. According to some embodiments, player card module 228 may replace credit input mechanism 221 in a gaming machine 100.

A payout mechanism 225 is mounted beneath the console 102 and is provided for cash payouts from the machine 100 to the player. According to some embodiments, payout mechanism 225 comprises a coin hopper 227 which dispenses coins or tokens equal to the amount of credit currently on the machine, into a coin tray 116. Aside from the coin hopper 227 and coin tray 116, the payout mechanism 225 may also include one or more of: a ticket dispenser 226 for issuing a ticket dispensed by a printer which the user can redeem for cash; a note dispenser; a near field communications transmitter; or other means to enable wireless or remote credit transfer. A ticket dispensed by ticket dispenser 226 may be able to be redeemed by a player at a cashier station at the gaming venue. According to some embodiments, ticket dispenser 226 may be configured to communicate with payout component 224 via a serial or USB interface. It should be appreciated that any suitable payout mechanisms, such as funding to the player's electronically recordable identification card or smart card, may be implemented in accordance with the gaming machine 100 disclosed herein. According to some embodiments, player card module 228 may act as a payout mechanism. According to some embodiments, player card module 228 may replace credit input mechanism 221 in a gaming machine 100.

The gaming machine 100 further includes audio output 208 (shown in FIG. 2) to provide auditory feedback to the player of the gaming machine 100. According to some embodiments, audio output 208 may comprise one or more speakers, subwoofers, earphones, or other audio output mechanisms. In some embodiments, audio output 208 may provide a stereo audio output. According to some embodiments, audio output 208 may comprise two speakers and a subwoofer.

During game play on gaming machine 100, a player may: read game play instructions via video display unit 104 and/or secondary screen 120; insert credit into gaming machine 100 via credit input mechanism 221; initiate a game or series of games by interacting with user input 218 via pushbuttons 106 and/or touch screen 108; and observe the outcome of the game via video display unit 104, secondary screen 120 and/or audio output 208. A player may be able to collect any remaining or accumulated credit at any time via payout mechanism 225.

Referring to FIG. 2 of the drawings, game logic circuitry and componentry 200 is illustrated. The game logic circuitry and componentry 200 includes a gaming controller 201. The gaming controller 201 may be disposed in a logic cage, for example. The logic cage includes a box-like mechanical cage structure that has slots to guide logic cards into the proper location for electronically plugging into a backplane mounted at the rear of the cage structure. The backplane has connectors for accepting mating connectors on the logic cards. The logic cage and associated cards serve to at least partly define the functional capabilities of the game controller 201 and form one of the basic components of the gaming machine 100. The logic cage is securely housed within the cabinet of the gaming machine 100. Circuitry and componentry 200 may be configured to combine features of an industrial computer, such as ruggedness and reliability, with high processing power and 3D rendering capability sufficient to display entertaining games.

Central to the logic cage is at least one processor 202 which may act as a central processing unit and may include a processor, a microcontroller-based platform, a suitable integrated circuit, or one or more application-specific integrated circuits (ASICs). Processor 202 may include more than one processing chip or component, but the singular term processor 202 is used herein for convenience. Processor 202 may be configured to be powerful enough to be able to perform floating point calculations for a physics engine, and 3D rendering calculations to allow for the display of 3D animations. According to some embodiments, processor 202 may comprise at least a dual core CPU capable of running at at least 1.6 GHz. The processor 202 is in communication with or operable to access or to exchange signals with memory 204. Memory 204 may comprise RAM, ROM, a non-volatile memory in the form of a compact flash, battery backed up memory, or other memory devices. RAM may include DRAM, non-volatile RAM (NVRAM), magnetic RAM (MRAM), ferroelectric RAM (FeRAM), and other forms as commonly understood in the gaming industry.

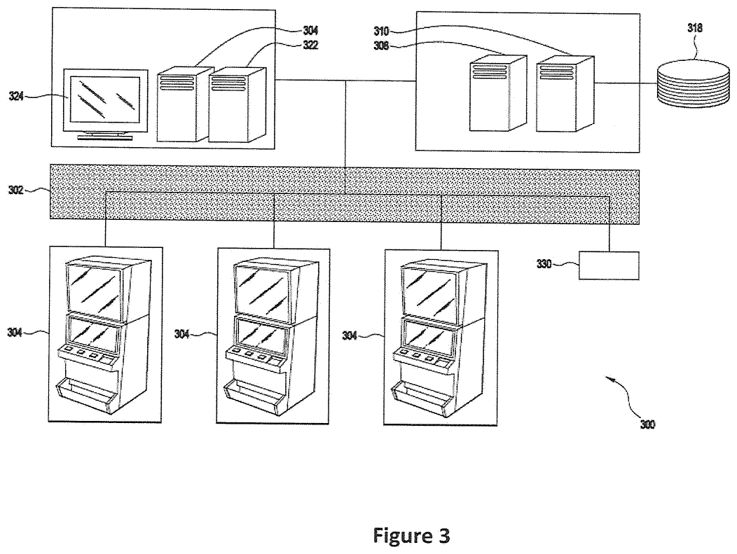

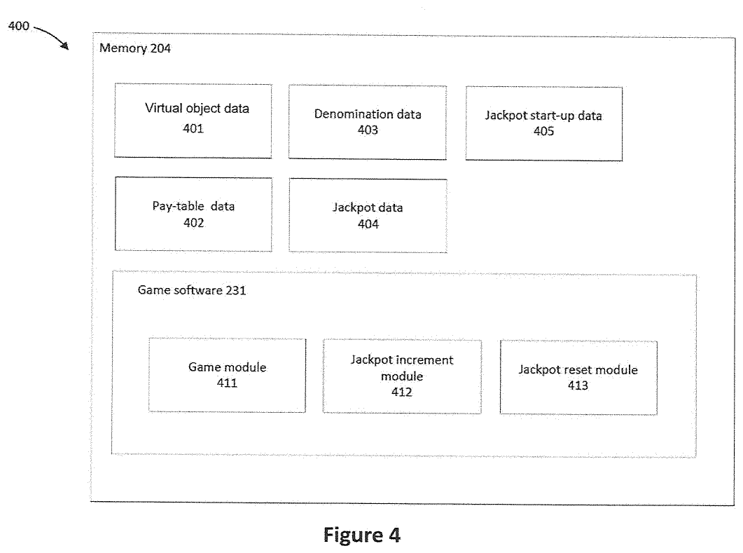

Memory 204 stores game software module 231. Game software module 231 comprises one or more executable code modules accessible by processor 202. Game software module 231 may store game pay logic rules and credit processing rules, that govern when and how much credit a player should receive based on the outcome of a game, as well as processing credit input by the player. Game software module 231 may also store game graphics code and resources that allow processor 202 to cause graphics to be generated and displayed via video display component 212, and audio processing instructions that allow processor 202 to instruct audio control component 209 to generate audio data. Game software module 231 may further store input/output processing software to allow processor 202 to facilitate communications between gaming controller 201 and user inputs 218, as well as outputs 208, 104, 120 and 211. According to some embodiments, game software module 231 may also store communications software that allows gaming machine 100 to communicate with external devices, as described in further detail below with reference to FIG. 3. According to some embodiments, memory 204 may comprise at least 4 GB of DRAM, to allow for game software module 231 to be stored on DRAM.

According to some embodiments, gaming machine 100 may comprise safety intrusion monitoring and security. This may comprise one or more sensors on the body and inside gaming machine 100, to detect unauthorised tampering with gaming machine 100. Gaming machine 100 may also comprise power failure handling and recovery features, which may include back-up battery systems and battery-backed up recovery memory devices that preserve data should a power down period occur where gaming machine 100 loses power. According to some embodiments, gaming machine 100 may comprise at least 2 MB of battery backed up storage. Gaming machine 100 may also comprise a logging microprocessor operating on battery power to perform intrusion monitoring functions during a power down period.

Processor 202 may also be in communication with audio output 208 via an audio control module 209. The audio control module 209 has its own digital signal processor, analogue to digital converters, amplifiers and other circuitry necessary to broadcast the output from the speakers.

The processor 202 runs executable code residing in game software module 231 of memory 204 that facilitates play of the game by a player through the display devices 104 and 120, and/or pushbuttons 106 and touchscreen 108 mounted in display devices 104 and 120. Processor 202 may communicate with user input 218 via user input component 216, and with video display unit 104, secondary screen 102 and edge lighting 211 via video display component 212. Video display component 212 may comprise a graphics processing unit (GPU) 213 to allow graphics to be generated, as well as video memory 214 configured to store data for display. GPU 213 may comprise a 3D programing application programming interface (API), which may be an OpenGL, Vulcan, or DirectX API, for example. GPU 213 is preferably powerful enough to allow for graphics to be generated on-the-fly and displayed on video display unit 104 and/or secondary screen 120. Where video display unit 104 and secondary screen 120 have a resolution of 1920×1080 each, for example, GPU 213 may be configured to be powerful enough to perform real-time rendering of a resolution of 1920×2160 (combined) at a refresh rate of 60 Hz. According to some embodiments, the speed of rendering performed by GPU 213 may be at least 100 frames per second. According to some embodiments, GPU 213 may be configured to support BC7 compression.

Data used by GPU 213 may be stored in video memory 214, which may comprise a form of DRAM, such as video random access memory (VRAM). VRAM may be used as VRAM may be faster than DRAM, although in some embodiments DRAM may also be used as VRAM. According to some embodiments, video memory 214 may comprise at least 1 GB of VRAM.

The processor 202 may receive input signals from user input 218 and drive the screen of video display unit 104 and/or secondary screen 120

Processor 202 may also receive input signal pulses from credit input component 220 and payout component 224 to determine whether or not a player has provided sufficient credit from either payment device 114 or 222 to commence playing, and to instruct payout component 224 to dispense payment to a player. Credit input component 220 and payout component 224 may communicate with credit input mechanism 221 and payout mechanism 225 via an electrical signal interface.

Metering information may be stored in hard meters 207, which may be read and modified by processor 202 via hard meter interface 206. The values in hard meters 207 are only ever incremented, and cannot be reset or decremented. The only way to alter the values stored is by running the executable code stored in game software module 231, which is executed by processor 202. The game software module 232 contains the rules of the game, the sequence of gameplay, communicates with external systems, monitors peripheral equipment, maintains integrity of the software code, etc. The processor 202 continually checks for error conditions.

According to some embodiments, processor 202 may further be in communication with a random number generator 210, to generate random numbers as required to implement one or more games of chance. Random number generator 210 may be configured to include cryptographic hashes to allow for cryptographic random number generation.

In one embodiment, gaming machine 100 may comprise a player card module 228, allowing a player to insert an identification card into a card reader (not shown) as a way of inserting and receiving credit. The player's credit amount may be stored on the card, or may be linked to data stored on the card. Such an identification card may be a smart card having a programmed microchip, a coded magnetic strip, or coded rewritable magnetic strip, wherein the programmed microchip or magnetic strips are coded with a player's identification, credit totals (or related data), and/or other relevant information. In another embodiment, a player may carry a portable device, such as a mobile phone, a radio frequency identification tag, or any other suitable wireless device, that communicates a player's identification, credit totals (or related data), and other relevant information to the gaming machine 100. Player card module 228 may be in communication with a monitoring system 229 to verify cards inserted into player card module 228. Monitoring system 229 may store identification card numbers along with data associated with the card such as player identification, credit totals, and/or other relevant information. According to some embodiments, data stored on monitoring system 229 may be used where a player loses or damages their card. FIG. 3 shows a gaming system 300 in accordance with an alternative embodiment. The gaming system 300 includes a network 302, which for example may be an Ethernet network. Gaming machines 304 are connected to the network 302. The gaming machines 304 provide a player operable interface and may be the same as the gaming machines 100 shown in FIG. 1 or may have simplified functionality depending on the requirements for implementing game play.

In a thick client embodiment, game server 308 implements part of the game played by a player using a gaming machine 304 and the gaming machine 304 implements part of the game. With this embodiment, as both the game server 308 and the gaming device implement part of the game, they collectively provide a game controller. A database management server 310 may manage storage of game programs and associated data for downloading or access by the gaming devices 304 in a database 318.

In a thin client embodiment, game server 308 implements most or all of the game played by a player using a gaming machine 304 and the gaming machine 304 essentially provides only the player interface. With this embodiment, the game server 308 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 300, including for example a gaming floor management server 320, and a licensing server 322 to monitor the use of licenses relating to particular games. An administrator terminal 324 is provided to allow an administrator to run the network 302 and the devices connected to the network.

The gaming system 300 may communicate with other gaming systems, other local networks, for example a corporate network, and/or a wide area network such as the Internet, for example through a firewall 330.

Persons skilled in the art will appreciate that in accordance with known techniques, functionality at the server side of the network may be distributed over a plurality of different computers. For example, elements may be run as a single “engine” on one server or a separate server may be provided. For example, the game server 308 could run a random generator engine. Alternatively, a separate random number generator server could be provided. Further, persons skilled in the art will appreciate that a plurality of game servers could be provided to run different games or a single game server may run a plurality of different games as required by the terminals.

Game data stored by memory component 204 includes any one or more of: virtual object data 401, pay-table data 402, denomination data 403, jackpot data 404, visualisation data 405.

Virtual object data 401 may include data relating to the virtual objects to be displayed on a display screen 108 of the visual display unit 104 of gaming machine 100 by processor 202 during a game. For example, the particular images used for each symbol may be stored, as well as an identification code relating to the symbol, and a value of the symbol.

In some embodiments, the virtual object data 401 comprises alpha-numeric symbol data relating to at least one of a subset of numeric symbols and/or a subset of alphabetical letters. For example, the numeric symbols may represent numbers 2 to 10 and the alphabetical letters may comprise the set of A, J, Q, K to thereby represent elements of a standard western playing card deck. The virtual object data 401 may also comprise class symbol data relating to different classes (or suites) which when combined with alpha-numeric symbols define the identifier of a virtual object. For example, the class symbol data may represent any one or more of the following fruits: watermelon, banana, lemon, cherries, oranges, berries, and apples. In some embodiments, the class symbol data may represent playing card suites such as diamonds, clubs, hearts, and spades.

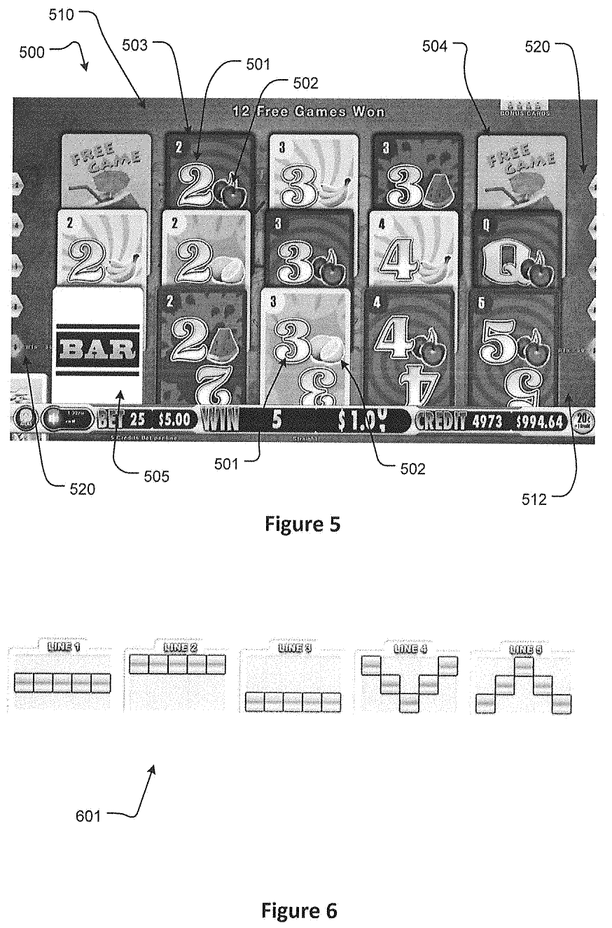

FIG. 5 shows an example screen shot of a game display 500 that displays an array 512 of virtual objects 503. The example game display 500 has the virtual objects arranged in a 3 by 5 rectangular array 512 512. Each virtual object 503 has an identifier.

As illustrated in FIG. 5, an alpha-numeric symbol 501 may be combined with a class symbol 502 to represent the identifier of a virtual object 503. In some embodiments, the virtual object data 401 defines a set of virtual objects 503 by their identifiers. For example, the identifiers of the set of virtual objects 503 may be defined by combinations of a fixed number (e.g. four) of types of class symbols 502 and a fixed number of alpha-numeric symbols 501. Such class symbols 502 and alpha-numeric symbols 501 are each different from each other. The class symbols 502 may be represented by different fruits, for example. The alphanumeric symbols 501 may be represented by: A, 2 to 10, J, Q, and K, for example. In an example set of four classes with thirteen alphanumeric symbols, there would be 52 unique identifiers for the set of virtual objects 503. The identifiers of a set of virtual objects 503 are stored in the virtual object data 401.

In some embodiments, the virtual object data 401 comprises a set of identifiers of virtual objects 503 defined by combinations of alpha-numeric symbols and classes such as:
A-lemon, 2-lemon, 3-lemon, 4-lemon, 5-lemon, 6-lemon, 7-lemon, 8-lemon, 9-lemon, 10-lemon, J-lemon, Q-lemon, K-lemon;
A-watermelon, 2-watermelon, 3-watermelon, 4-watermelon, 5-watermelon, 6-watermelon, 7-watermelon, 8-watermelon, 9-watermelon, 10-watermelon, J-watermelon, Q-watermelon, K-watermelon;
A-banana, 2-banana, 3-banana, 4-banana, 5-banana, 6-banana, 7-banana, 8-banana, 9-banana, 10-banana, J-banana, Q-banana, K-banana;
A-cherry, 2-cherry, 3-cherry, 4-cherry, 5-cherry, 6-cherry, 7-cherry, 8-cherry, 9-cherry, 10-cherry, J-cherry, Q-cherry, K-cherry.

In some embodiments, each of the above-identified virtual objects 503 is unique among the set of virtual objects 503. However, in other embodiments, the stored identifiers of the virtual objects 503 may not all be unique and a limited number (e.g. 2, 3 or 4) of multiples of each identifier may be present in the symbol data 401. This enables virtual objects 503 of the same identifier to be selected from the identifiers stored in the symbol data 401 even if selection from the stored identifiers is conducted without replacement. For example, there may be duplicates or triplicates of each unique identifier stored. For card-based games, this allows multiple decks (or sets) of cards to be used for play of the game.

The symbol data 401 may also comprise special symbols that represent free-game virtual objects 504 or wild-card virtual objects 505. The free-game virtual object 504 may, for example, be represented by graphics for a playing card with the words ‘free-game’ or a predetermined image or animation.

During game play, the wild-card virtual object 505 may, for example, be substituted for any other standard virtual object 503 when evaluating combinations of virtual objects 503. For example, the wild-card virtual object 505 can be substituted for any other virtual object 503 that corresponds to an identifier defined by an alpha-numeric symbol and a class combination (but not a free-game object 504). The wild-card virtual object 505 may, for example, be represented by graphics for a playing card with the words BAR, as shown in FIG. 5, or an image of a fruit, a predetermined image or animation (e.g. an animated image of a fruit), or a joker player card. In some embodiments, the free-game card is also a wild-card.

The visualisation data 405 may include data relating to the virtual objects 503 to be displayed on a display of the visual display unit 104. For example, virtual objects 503 may be displayed as representations of playing cards with various graphical elements on one virtual face of the virtual card. The graphical elements may include one or more symbols to enable the identifier of the virtual object 503 to be observed by the player. For example, as described above, the identifier may be defined by an alpha-numeric symbol 501 and a class symbol 502.

Pay-table data 402 may include data relating to a pay-table used in the game played on gaming machine 100. Pay-table data 402 may comprise data defining winning combinations of identifiers of virtual objects 503.

In some embodiments, pay-table data 402 may define one or more algorithms (or a set of rules) for determining whether a selected combination of virtual objects 503 matches a winning combination based on the identifiers of the virtual objects 503. For example, an algorithm may be used to determine a winning combination (‘3 of a kind’) if there are at least three matching alpha-numeric symbols 501 at least partially representing the identifiers of virtual objects 503 in a combination of virtual objects 503, i.e. regardless of the class symbol 502. In another example, an algorithm may be used to determine a winning combination (‘straight flush’) if there are five consecutive alpha-numeric symbols 501 in a combination of virtual objects 503 and where each of the five virtual objects 503 are defined by the same class symbol 502.

Winning combinations may include a combination of virtual objects 503 with identifiers corresponding to any one or more of: two groups of two identifiers with matching symbols (two pairs), any multiples of 3 or more symbols (e.g. 3 of a kind, 4 of a kind, 5 of a kind), multiple of 5 or more matching classes (flush), a group of two virtual objects with matching symbols and group of three with matching symbols (full house), five consecutive alpha-numeric symbols 501 (straight), consecutive alpha-numeric symbols 501 and the same class symbols 502 (straight flush), consecutive alpha-numeric symbols 501 comprising at least 10, J, Q, K, A and the same class symbols 502 (royal flush). These combinations may be familiar to the player and thereby aid in reducing the time taken for the player to learn the game rules. Familiarity with these combinations may also aid the player to more quickly recognise winning combinations during game play and therefore increase excitement and enjoyment of the game.

FIG. 6 shows various available play lines through the rectangular array 512 of virtual objects shown in FIG. 5. Five available play lines are illustrated as an example. Play line 1 may be a middle row, play line 2 may be a top row and play line three may be a bottom row, for example. Play line 4 may be an inverted chevron shape and play line 5 may be a chevron shape, for example. If a set of virtual objects 503 appears in a pattern in the array 512 that corresponds to a selected play line, and that set of virtual objects 503 meets the criteria for a winning combination, then processor 202 determines that a winning result of the game play has occurred.

In some embodiments, pay-table data 402 comprises stored combinations of virtual objects 503 that result in a winning combination. The pay-table data 402 may comprise all of the possible combinations of virtual objects 503 that constitute a winning combination without storing every possible combination of virtual objects 503. Additionally, if selected combinations during game play comprise more virtual objects than necessary for a winning combination, it is not necessary to store every combination including additional virtual objects that do not contribute to the winning combination. For example, if five virtual objects are selected and two groups of matching pairs (‘two pairs’) are considered a winning combination; the pay table data 402 may therefore comprise all the possible combinations of two pairs (combinations of 4 virtual objects) rather than all the possible combinations of 5 virtual objects. This advantageously reduces the number of combinations that are required to be stored in memory 204.

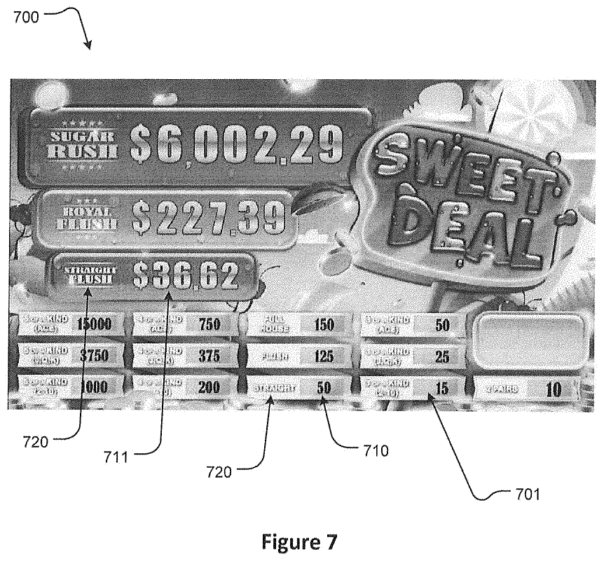

The pay-table data 402 also comprises a payout value or factor for each winning combination. Referring to FIG. 7, in an example display 700, some of the pay-table data 402 may be displayed as a pay-table 701 on an upper display screen 108 of the visual display unit 104. The pay-table 701 may indicate the payout 710 for groups or types of combinations 720. The payout 710 may indicate or account for a multiplier of the bet denomination. Alternatively, a fixed cash payout 711 may be indicated where winnings are not dependent on the bet denomination.

Rarer object combinations may have higher payouts. As discussed above, by using familiar combinations to the player, combinations may be readily recognised by the player and the player may therefore readily determine which combinations have higher payouts. This may lead to increased excitement and enjoyment during game play.

Pay-table data 402 may be used by processor 202 to calculate and/or determine whether one or more winning events has occurred on gaming machine 100. Winning events may include jackpot winning events, as well as other winning events. Pay-table data 402 may be used by processor 202 to determine the amount won based on which combination of symbols appear on a display screen 108 of the visual display unit 104, including whether a jackpot amount has been won. Pay-table data 402 may also be used by processor 202 to calculate and/or determine the amount won by a player based on the winning combination.

Denomination data 403 may store possible denomination amounts for betting by a player to initiate a game on gaming machine 100. A denomination amount may be a value of 1 credit. For example, in some embodiments a “1c” denomination will mean that 1 credit equals one cent. In this case, when a player elects to play 60 lines at 1 credit bet per line, they bet 60c. A denomination of “5c” may mean that 1 credit equals five cents. In this case, if a player elects to play 20 play lines at 2 credits bet per line, the wager is 40 credits, or $2.00. Denomination data 403 may store the number of denominations available, as well as the value of the bet for each bet denomination. For example, denomination data 403 may store three denominations, being 1c, 2c and 5c. In another example denomination data 403 may store four denominations, being 1c, 2c and 5c and 10c. The bet denomination may be a multiple of a minimum bet where the multiple is selected as a bet multiplier by the player. For example, a gaming machine may define a minimum bet of 5c, the player may be presented with the option of selecting a bet multiplier of 1×, 2×, 5× and 10× to thereby select bet denominations of 5c, 10c, 25c, and 50c. In some embodiments, selecting the number of play lines defines the bet multiplier. In some embodiments, the selection of playing a plurality of play lines multiplies the bet denomination to further increase the total wager. Once a player has started a game on gaming machine 100, processor 202 may also store the current denomination value being played by the player in denomination data 403.

In some embodiments, code modules within game software module 231 may include game module 411, jackpot increment module 412, and jackpot reset module 413.

Game module 411 may be executable by processor 202 to cause a game, which may be a card game in some embodiments, to be displayed on visual display unit 104. The game may be a chance-based game, in which a main (first) subset 510 of virtual objects 503 is displayed on a display screen 108 of the visual display unit 104.

Each virtual object 503 in the main subset 510 is randomly selected (drawn) from a larger set of virtual objects 503 stored in memory component 204 by processor 202. For example, selecting each virtual object 503 may be based on a random number that is generated. As described above, each virtual object 503 has an identifier that may be characterised by an alpha-numeric symbol 501 and a class symbol 502. The main subset 510 may be displayed as a visualisation along with other graphic elements to display a virtual object 503 or part of another virtual object. For example, the virtual object 503 may be displayed as any one of: a playing card, an image, an icon, and a section of a slot reel.

The larger set of virtual objects 503 from which the main subset is randomly selected from is sized to permit a reasonable degree of variation among the selected symbols across a significant number of instances of identifiers for the virtual objects 503.

Game module 411 may be executed by processor 202 when a player initiates game play using user input 218. Game module 411 may allow a player to make a bet or wager using credit input mechanism 221, input mechanisms 106, and user input 218, and may determine a random game outcome using random number generator 210. Executing game module 411 may cause processor 202 to determine whether the player won any credits or other awards using base-game pay-table data 402. Processor 202 may then cause gaming machine 100 to credit the player with any winnings using payout mechanism 225.

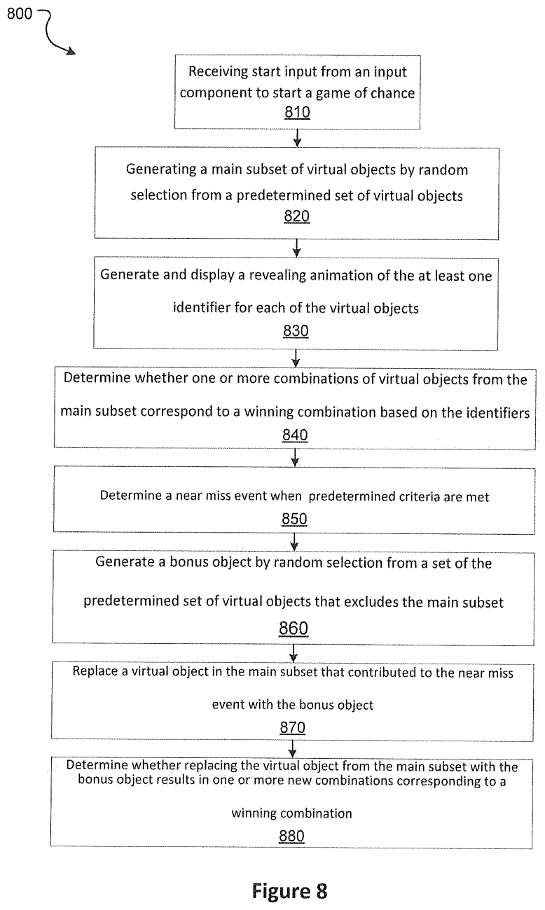

Referring to FIG. 8, a flow chart 800 is shown illustrating a method of operating a game of chance. The method may be implemented on a gaming system such as gaming machine 100 and is encoded in executable program code stored as a set of instructions on the memory 204. The processor 202 is configured to execute the program code to cause the gaming machine 100 to perform the method.

The method comprises the processor 202 receiving start input from one of the input components 106, 107 to start play of a game of chance, at 810. In response to the processor 202 receiving the start input, the processor 202 generates a main subset 510 of virtual objects 503 by random selection from the predetermined set of virtual objects, at 820. The processor 202 generates and displays a revealing animation of the at least one identifier for each of the virtual objects 503 from the main subset 510 in an array 512 on the displays screen 108, at 830.

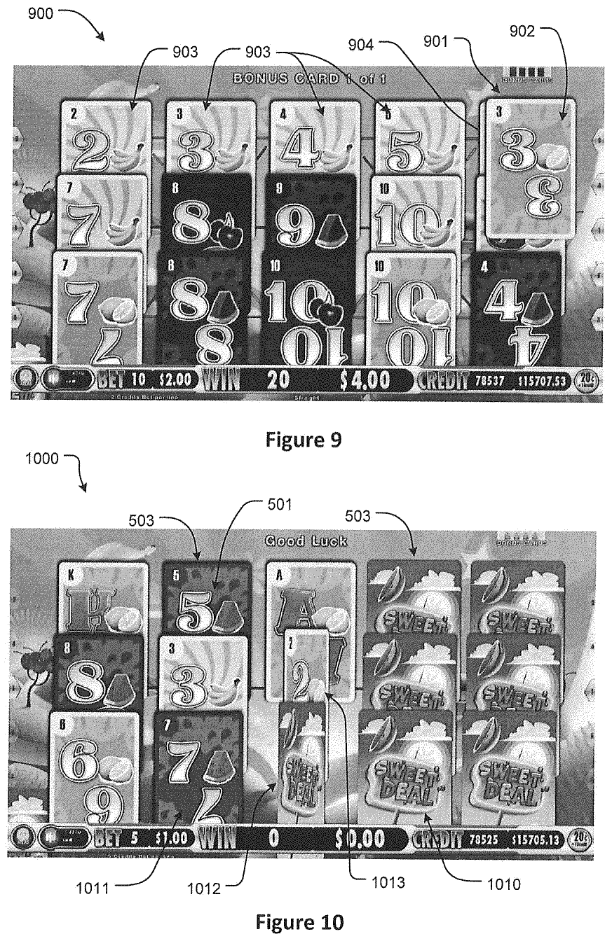

The method further comprises determining whether one or more combinations of virtual objects 503 from the main subset 510 correspond to a winning combination based on the identifiers of the virtual objects 503, at 840. In response to determining that no combinations from the main subset 510 correspond to a winning combination and when predetermined criteria are met, the processor 202 determines whether a near miss event has occurred. If a near miss event is determined to have occurred, the processor 202 generates a bonus object 901 by random selection from a set of the predetermined set of virtual objects that excludes the main subset, at 850. The processor 202 generates and displays a bonus animation that reveals the identifier of the bonus object 901 in the array 512, at 860. For example, a bonus object 901 with its identifier 902 revealed is shown in FIG. 9.

The processor 202 replaces a virtual object 503 in the main subset that contributed to the near miss event with the bonus object 901, at 870, as depicted in FIG. 9. The processor 202 also determines whether replacing the virtual object 503 from the main subset 510 with the bonus object 901 results in one or more new combinations corresponding to a winning combination, at 880.

The start input may comprise selecting a bet multiplier in order to set (or select) the bet denomination. In some embodiments, the player may also select the number of play-lines to play and the bet multiplier may depend on the number of play lines. For example, the player may select a bet multiplier by pressing a button 106 or touch screen icon (not shown) on the gaming machine 100.

In some embodiments, the start indication that leads to generation of the main subset 510 of virtual objects 503 may comprise the player input that selects the bet multiplier and/or number of play-lines. In other embodiments, the start indication is a separate input. For example, the start indication may comprise an input received as a result of a start button 107 or touch screen icon (not shown) being pressed.

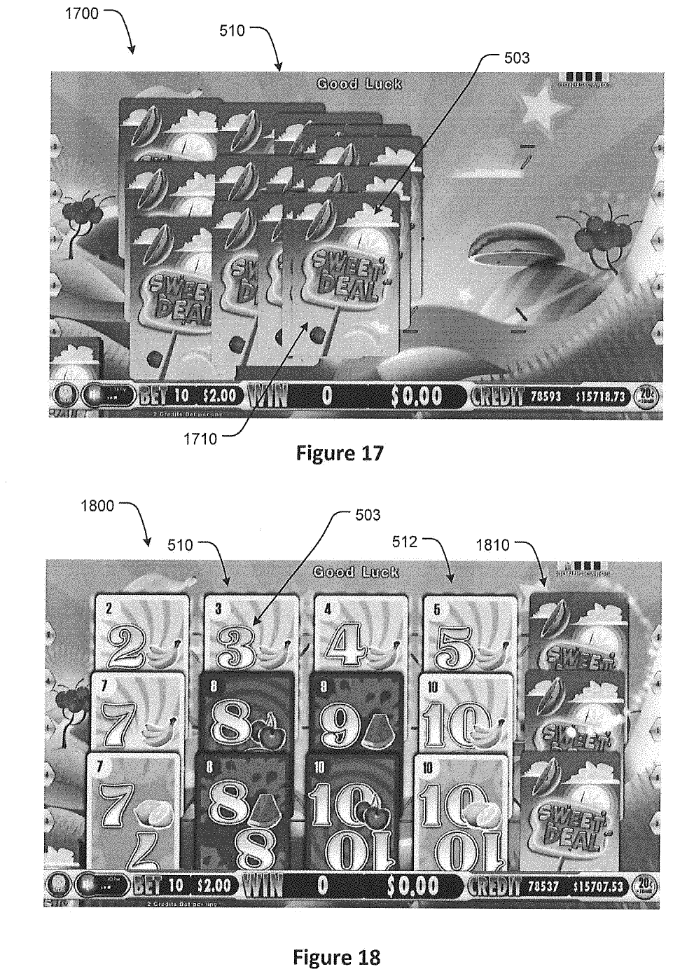

FIG. 17 shows a screenshot 1700 with a “dealing” animation that may be displayed to a user at the initiation of a game on gaming machine 100. The dealing animation may involve the generation of a main subset 510 of virtual objects 503, and the movement of a main subset 510 of virtual objects 503 across the screen to settle in predetermined positions of an array 512. Processor 202 may be configured to display the animation to simulate playing cards being dealt out onto a playing surface before a revealing animation reveals the identifier of each of the main subset 510 of virtual objects 503 that have been dealt.

Virtual objects 503 may be three dimensional objects having height, width and depth in some embodiments. In some embodiments, virtual objects 503 may be flat objects having front and back sides with width and height, but not depth. Virtual objects 503 may have a hidden orientation and a revealed orientation. In the hidden orientation, the identifiers 501 and 502 of each object 503 are not shown to the player. Instead, an image or symbol common to all of objects 503 may be displayed to the player, so that the player cannot distinguish one virtual object 503 from another. In FIG. 17, each of objects 503 are in a hidden orientation, showing only back side 1710 to the player.

Virtual objects 503 may be generated in an “off-screen” position, and appear to be dealt, thrown, or slid into the view of the player. Each virtual object 503 may have a predetermined start and end position. A physics engine may be used to generate the movement of virtual objects from their start positions to their end positions, creating the appearance of natural movement subject to forces such as friction and gravity. For example, the speed of virtual objects 503 may be gradually decreased as they near their predetermined end position, to create a natural motion as would occur if an object was to slide to a stop on a surface. The motion of objects 503 may be controlled to cause the objects 503 to each arrive in their end positions at the same time. Alternatively, each of the virtual objects 503 may arrive in their end positions at different times. According to some embodiments, the start position of each virtual object may be the same, and the virtual objects may be given the same initial velocity in the direction of their end positions, such that virtual objects 503 that have end positions further away from the start position than other virtual objects 503 would reach their end positions later than those other virtual objects 503.

Once each virtual object 503 is in its end position, a revealing animation or process may be applied to each object 503. In the reveal process, each object may transition from a hidden orientation to a revealed orientation. For example, the virtual object 503 may be flipped or rotated.

Referring to FIG. 10, the virtual objects 503 may be initially displayed as a set of first visualisations 1010 that do not reveal the identifiers. Each of the first visualisations 1010 may then be replaced with a corresponding second visualisation 1011 to thereby reveal the identifiers of the virtual objects.

During the revealing animation, the identifiers 501 for each of the virtual objects 503 from the main subset 510 may be gradually or progressively revealed. For example, each of the identifiers 501 for the virtual objects 503 may be revealed one after the other in sequence. In some embodiments, two or more identifiers 501 may be revealed at the same time. For example, the identifiers 501 for virtual objects 503 located in the same column may be revealed at the same time by the revealing animation. Displaying a revealing animation to gradually or progressively reveal the identifiers 501 may have the effect of creating a feeling of anticipation and building excitement in the player of the gaming machine 100 to enhance player experience.

In some embodiments, the virtual object 503 may be displayed as a playing card. The revealing animation may simulate one or more playing cards being flipped or turned over from a face down orientation 1010 to a face up orientation 1011. The revealing animation may therefore display the virtual objects 503 in intermediate orientations 1012, 1013 to simulate the flipping or turning of playing cards.

FIG. 18 shows all but one column 1810 of virtual objects in a revealed orientation, with only column 1810 remaining in a hidden orientation. This provides a high degree of player anticipation, as players can try to work out what, if any, winning combinations might result from the main subset 510. For example, in the embodiment illustrated in FIG. 18, the play line 1 could reveal a straight, play line 2 could reveal a flush, and play line 3 could reveal a three-of-a-kind, depending on the identifiers of objects 503 in column 1810.

Virtual objects 503 may be displayed in a two-dimensional array 512. The two-dimensional array 512 is preferably a rectangular array, however, a diamond-shaped or trapezoidal array is also possible. A diamond-shaped or trapezoidal array is considered to define at least one of diagonal rows or diagonal columns. In some embodiments, the array 512 has at least 3 columns. In a preferred embodiment the array 512 has 5 columns. In some embodiments, the array 512 has 3, 4, or 5 rows.

Determining whether one or more combinations of virtual objects 503 from the main subset 510 correspond to a winning combination or if the new combinations (following play of the bonus card(s)) correspond to a winning combination may comprise comparing the combinations or new combinations with a look-up table of winning combinations stored in the pay-table data 402 in memory 204. Alternatively, a set of rules stored in the pay-table data 402 may be applied to the combinations or new combinations to determine if any one or more combinations or new combinations corresponds to a winning combination.

If the processor 202 determines that one or more combinations of virtual objects 503 from the main subset 510 correspond to a winning combination or if the new combinations correspond to a winning combination, then a payout (winnings) is calculated based on the pay-table data 402.

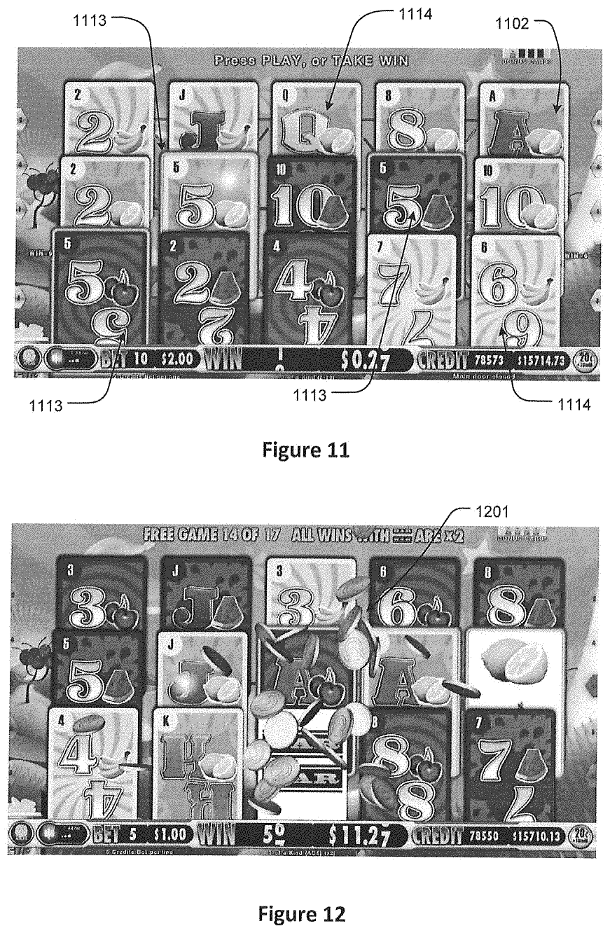

As illustrated in FIG. 11, in some embodiments, the virtual objects (matching virtual objects) 1113 in a combination that are determined to match identifiers with a virtual object in a winning combination may be displayed in an altered way to highlight the matching virtual objects 1113 in the combination. For example, where the triplets of the identifier ‘5’ is determined to match a winning combination then the display of the virtual objects 1113 along a play line that have identifiers ‘5’ may be altered to highlight the outline of the virtual objects 1113 in a certain way, such as by outlining them in neon blue. In some embodiments, an animation of the matching virtual objects 1113 may be displayed where the virtual object 1113 disappears and appears (‘blinks’). The display of the non-matching virtual objects 1114 is unchanged. Highlighting the matching virtual objects 1113 may enable the player to readily observe and recognise the winning combination which may lead to excitement and enjoyment by the player. Additionally, audio sounds or tunes can also be played back to accompany the determination of a winning combination to further enhance player experience.

Referring to FIG. 12, in response to determining a winning combination, a win animation may be displayed in some embodiments. For example, the win animation may simulate a large amount of cash such as coins 1201 being dropped or thrown in the visual foreground of the imagery shown on the display screen 108. The win animation may also or alternatively simulate cash notes being dropped or thrown.

The predetermined criteria for the near miss event may be determined by the processor 202 that a winning combination would occur if one or more predetermined virtual objects (e.g. from a winning combination) were present in a predetermined set of positions in the array 512.

Alternatively, the predetermined criteria for the near miss event may be determined by the processor 202 based on a predetermined number of un-matched virtual objects (not shown) from a winning combination. An un-matched virtual object is not in a winning combination while other matching virtual objects are part of the winning combination. In the example shown in FIG. 9, the matching virtual objects 903 have the potential to belong to a winning combination but the combination of virtual objects along the first row does not fully match the winning combination due to the un-matched virtual object in column 5. Criteria for determining a near miss event may include that the position of the un-matched virtual object (or possibly objects) in the main subset 510 are restricted to those located in a predetermined set of positions in the array 512. The set of predetermined positions may include one or more of the right-most column, middle column or left-most column, for example.

In some embodiments, the predetermined number of un-matched virtual objects is one or two. The replacement with bonus objects 901 therefore only applies if one or two virtual objects are un-matched from a winning combination.

In some embodiments, the predetermined criteria comprises when there are at least two virtual objects 503 (matching virtual objects 903) in each combination that match virtual objects in at least one winning combination. This sets a minimum number of matching virtual objects 903 required before a bonus object will replace a missing virtual object.

The predetermined set of positions for the predetermined criteria may comprise positions in either the first or last column of the array 512, for example. Therefore, if an un-matched virtual object is in other columns, the bonus object would not replace the missing virtual object in these embodiments.

The bonus animation to reveal the identifier 902 of the bonus object 901 may be the same or similar to the object-reveal animation. In some embodiments, the bonus object replaces and/or covers or obscures at least part of the missing (non-matching) virtual objects from the main subset 510 with the bonus object 901. For example, an un-matched virtual object part 904 may still be visible underneath the bonus object 901. The bonus animation may also reveal the bonus object 901 in a separate part of the display 108 and leave the main subset 510 visible.

The player may be provided with a prompt to initiate the generation and display of the bonus animation. This may enable a player to raise the initial bet denomination and be provided with bonus objects to replace missing virtual objects. Accordingly, the processor 202 may be configured to receive player input indicative of a draw request before displaying the bonus animation and determining if one or more replacement combinations corresponds to a winning combination. Having a player initiate the generation and display of the bonus animation may increase the anticipation and excitement associated with the bonus object 902 replacing the missing virtual object.

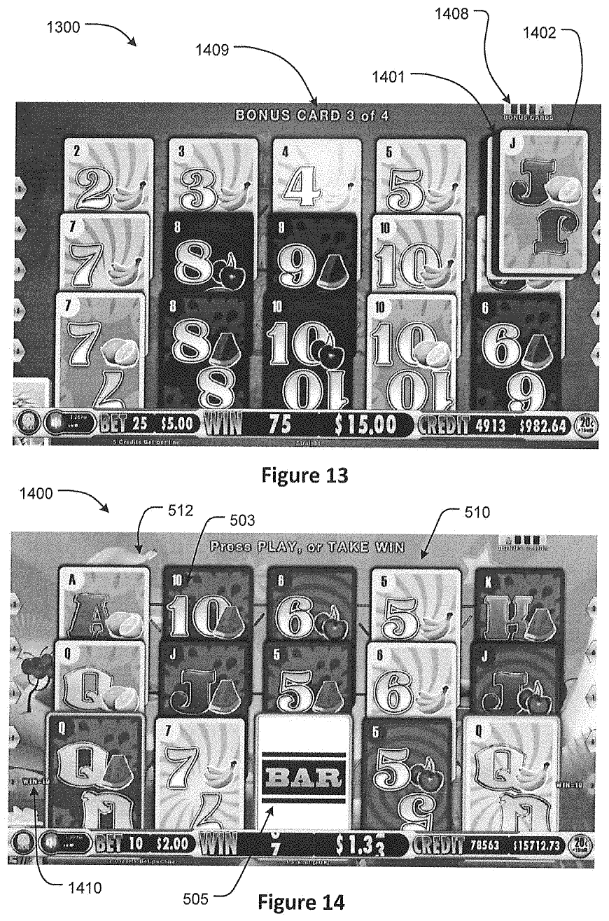

FIG. 13 illustrates an example display 1300 of a game scenario in which multiple bonus objects are awarded and played, following a near miss event. In some instances, replacement of an un-matched virtual object with a bonus object does not result in combination that matches a winning combination. The processor 202 may be further configured to generate a further bonus object 1401 by random selection from the predetermined set of virtual objects if the bet denomination is larger than a predetermined amount. A subsequent bonus animation may then be generated and displayed to reveal the identifier of the further bonus object 1401 to replace at least one of the previously revealed bonus objects 902 in the array 512.

The generation of further bonus objects and generation and display of subsequent bonus animation may be repeated a number of times depending on the size of the bet denomination. The number of times the generation can be repeated may be limited. For example, the number of times may be limited to 4 to enable up to 4 bonus objects to be successively generated for successive near miss events. The number of times the generation can be repeated may depend on the bet denomination and/or wager. A larger bet denomination may provide a larger number of repeats to generate a larger number of bonus objects. For example, the number of times the generation of further bonus objects and generation and display of subsequent bonus animation is repeated may be linearly or non-linearly proportional to the multiple of the minimum bet denomination.

An indication 1408 of the number of possible bonus objects that can be generated in a given game may be displayed on the display screen, for example as illustrated in display 1300. The indication 1408 may be displayed at the top right of the display screen, for example. In some embodiments, the display may also show an indication of how many bonus objects have been generated to replace an un-matched virtual object and therefore how many more bonus objects are remaining to be generated. This information may also be presented as written information 1409 on the display screen 108.

In some embodiments, the processor 202 may be configured to receive player input indicative of a number of play-lines 601. Each play-line 601 passes through one virtual object 503 in each column of the array 512 512. This enables a player to select game play for a lower wager where not all of the predetermined play-lines 601 are played. The combinations of virtual objects from the main subset considered in the game play and compared to winning combinations are restricted to those that lie along predetermined play-lines 601 based on the number of play lines. For example, if a player selects to play 5 play-lines, the game play may be restricted to the play-lines shown in FIG. 6 rather than any 5 play-lines.

Referring to FIG. 14, a game scenario is shown where a wild-card 505 provides a winning combination on play line 3, corresponding to the bottom row of virtual objects 503. A win status message 1410 is shown to highlight the winning combination. Play line 3 contains Q-watermelon, 7-banana, BAR, 5-cherry and Q0banana cards. A line having three Q-type cards would ordinarily result in a “three-of-a-kind”outcome. Play line 3 only contains two Q-type cards. However, the BAR card, being a wild-card 505, can take the place of any other card in the deck. In the illustrated embodiments, wild-card 505 takes on the properties of a Q-type card, providing a “three-of-a-kind” outcome on play line 3, as if play line 3 contained three Q-type cards.

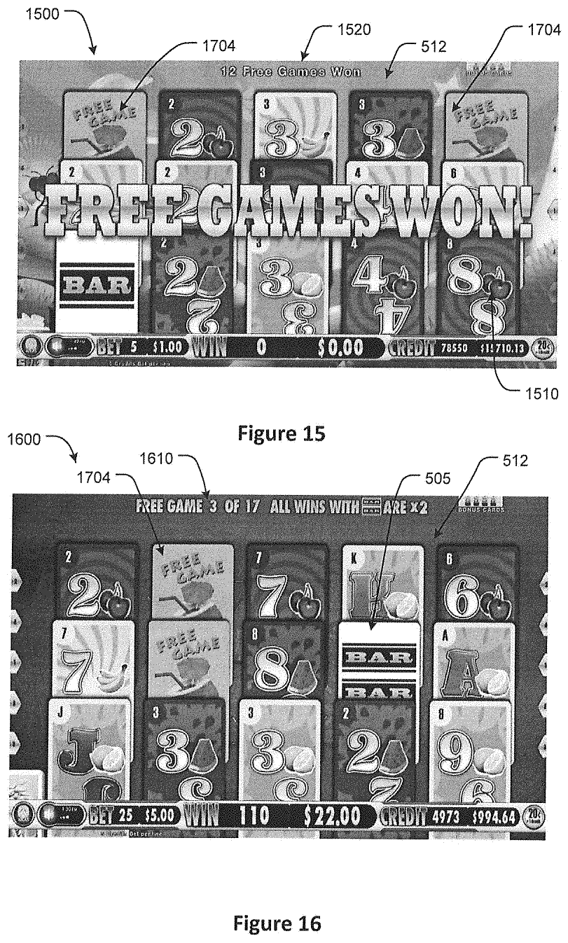

Referring to screenshot 1500 of FIG. 15, a free-game style of play may be triggered by the presence of ‘free-game’ virtual objects 1704. In the illustrated embodiment, two ‘free-game’ virtual objects 1704 are present in the first and last column of the array 512, triggering the free-game scenario. In some embodiments, any number of free-game objects 1704 may trigger a free-game scenario. In some embodiments, a predetermined number of free-game objects 1704 may need to appear to trigger the free-game scenario. According to some embodiments, free-game objects 1704 may need to appear in predetermined positions to trigger a free-game scenario.

When a free-game scenario is triggered, an animation or display may be shown to the user to indicate that that one or more free games have been won. For example, in the illustrated embodiment, “Free games won!” banner 1510 is displayed in front of array 512 of virtual objects 503, to notify the user of the free-game scenario being triggered. Furthermore, a label 1520 appears, indicating the number of free games won. In the illustrated example, the text notifies the user that 12 free games have been won. The number of free games won may be affected by the number of free-game objects 1704 displayed, and/or the location and relative position of any displayed free-game objects 1704 within the array 512.

FIG. 16 shows a screenshot 1600 with a free-game scenario in progress. Label 1610 provides progress information to the user. For example, in the illustrated embodiment, label 1610 informs the user that they are currently playing their 3^{rd} free game of a total of 17 free games they have won.

In some embodiments, during a free-game scenario, winning combinations comprising a wild-card 505 provide increased pay-out. This may be indicated as a written notification on the display. For example, in the illustrated embodiment, label 1610 states that all wins including the wild-card symbol 505 are increased by two.

According to some embodiments, during a free game scenario, the appearance of free-game objects 1704 may cause further free games to be awarded. For example, according to some embodiments, if at least two free-game objects 1704 are displayed anywhere on array 512, five more free games may be awarded to the player. The total number of free games available to the player may be updated on label 1610.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A gaming machine, comprising:
a memory component storing:
executable program code,
virtual object data relating to a predetermined set of virtual objects, wherein each virtual object has at least one identifier, and
a pay table defining a set of winning combinations of virtual objects;
a display screen;
input components to receive player input; and
at least one processor configured to execute the program code to:
receive start input from one of the input components to start play of a game of chance;
in response to receiving the start input, generate a main subset of virtual objects by random selection from the predetermined set of virtual objects;
generate and display a revealing animation of the at least one identifier for each of the virtual objects from the main subset in an array on the display screen;
determine whether one or more combinations of virtual objects from the main subset correspond to a winning combination based on the identifiers of the virtual objects;
in response to determining that no combinations from the main subset correspond to a winning combination:
determine a near miss event when predetermined criteria are met,
generate a bonus object by random selection from a subset of the predetermined set of virtual objects that excludes the main subset, and
generate and display a bonus animation that reveals the identifier of the bonus object in the array;
replace a virtual object in the main subset that contributed to the near miss event with the bonus object; and
determine whether replacing the virtual object from the main subset with the bonus object results in one or more new combinations corresponding to a winning combination.

2. The gaming machine of claim 1, wherein the processor is configured to:
display a set of first visualisations representing the main subset of virtual objects in the array on the display screen, wherein the first visualisations do not reveal the identifiers of the virtual objects; and
replace each first visualisation with a corresponding second visualisation to thereby reveal the identifiers of the virtual objects.

3. The gaming machine according to claim 2, wherein the processor is configured to display an animation of the set of first visualisations being progressively displayed in the array.

4. The gaming machine according to claim 1, wherein the displayed animation progressively reveals the identifiers of the main subset of virtual objects selected.

5. The gaming machine according to claim 1, wherein determining the near miss event comprises determining that a winning combination would occur if one or more predetermined virtual objects were present in a predetermined set of positions in the array.

6. The gaming machine according to claim 5, wherein there are one or two predetermined virtual objects.

7. The gaming machine according to claim 1, wherein the predetermined criteria for the near miss event comprises a predetermined number of un-matched virtual objects from a winning combination in a predetermined set of positions in the array.

8. The gaming machine according to claim 5, wherein the predetermined set of positions comprises positions in either the first or last column of the array.

9. The gaming machine according to claim 1, wherein the processor is further configured to execute program code to:
receive play line input from at least one of the input components indicative of a number of play lines selected for play of the game of chance, and
wherein combinations of virtual objects from the main subset lie along predetermined play lines, and each play line passes through one virtual object in each column of the array.

10. The gaming machine according to claim 1, wherein the start input from the player comprises an indication of a bet denomination.

11. The gaming machine according to claim 1, wherein
the predetermined criteria are at least partially satisfied when there are at least two virtual objects in each combination that match virtual objects in at least one winning combination.

12. The gaming machine according to claim 10, wherein when the bet denominator is larger than a predetermined amount and the new combination does not match a winning combination, the processor is further configured to:
generate a further bonus object by random selection from the predetermined set of virtual objects; and
generate and display a subsequent bonus animation that reveals the identifier of the further bonus object to replace at least one of the previously revealed bonus object in the array.

13. The gaming machine according to claim 1, wherein the generation of further bonus objects and generation and display of subsequent bonus animation is repeated a number of times depending on the size of a bet denomination.

14. The gaming machine according to the preceding claim 13, wherein the number of times the generation of further bonus objects and generation and display of subsequent bonus animation is repeated is linearly proportional to the multiple of the minimum bet denomination.

15. The gaming machine according to claim 1, wherein the revealing animation simulates the playing cards being flipped from face down to face up.

16. The gaming machine of claim 1, wherein the predetermined set of virtual objects comprises a predetermined number of free-game virtual objects, wherein if one or more free-game virtual objects is selected as part of the main subset for the game of chance, then at least one free game play of the game of chance is awarded to a player of the gaming machine.

17. The gaming machine of claim 16, wherein a number of free game plays awarded depends on the number of free-game virtual objects selected as part of the main subset and/or depends on the position of the respective free-game virtual objects in the array.

18. The gaming machine of claim 1, wherein the predetermined set of virtual objects comprises a predetermined number of wild-card virtual objects, wherein if one or more wild-card virtual objects is selected as part of the main subset for the game of chance, then the processor allocates to the at least one wild-card virtual object at least one identifier to attempt to make a winning combination of virtual objects.

19. A method of operating a gaming machine, comprising:
receiving start input from an input component of the gaming machine to start play of a game of chance;
in response to receiving the start input, generating a main subset of virtual objects by random selection from a predetermined set of virtual objects;
generating and displaying a revealing animation of at least one identifier for each of the virtual objects from the main subset in an array on a display screen of the gaming machine;
determining whether one or more combinations of virtual objects from the main subset correspond to a winning combination based on the identifiers of the virtual objects in the main subset;
in response to determining that no combinations from the main subset correspond to a winning combination:
determining a near miss event when predetermined criteria are met,
generating a bonus object by random selection from a subset of the predetermined set of virtual objects that excludes the main subset, and
generating and displaying a bonus animation that reveals the identifier of the bonus object in the array;
replacing a virtual object in the main subset that contributed to the near miss event with the bonus object; and
determining whether replacing the virtual object from the main subset with the bonus object results in one or more new combinations corresponding to a winning combination.

20. The method of claim 19, further comprising:
displaying a set of first visualisations representing the main subset of virtual objects in the array on the display screen, wherein the first visualisations do not reveal the identifiers of the virtual objects; and
replacing each first visualisation with a corresponding second visualisation to thereby reveal the identifiers of the virtual objects.
